(19) United States
(12) Patent Application Publication
(10) Pub. No.: US 2003/0053558 A1
(43) Pub. Date: Mar. 20, 2003

(54) Digital down converter

(76) Inventors: David Unger, Windham, NH (US); Willem Engelse, Schiedam (NL); William Corley, Foxborough, MA (US); David Davies, Chelmsford, MA (US); Paul Dormitzer, Acton, MA (US); Raymond Robidoux, Windham, NH (US)

Correspondence Address: LEFFERT JAY & POLGLAZE, P.A., P.O. BOX 581009, MINNEAPOLIS, MN, 55458-1009, US

(21) Appl. No.: 09/935,211

(22) Filed: Aug. 22, 2001

(51) Int. Cl. H04L 27/14

(52) U.S. Cl. 375/316

(57) ABSTRACT

A digital down converter is provided. The digital down converter includes an input adapted to receive an input signal, a mixer circuit coupled to the input to down convert the input signal, and a decimation circuit, coupled to the mixer. The decimation circuit is adapted to decimate the down converted signal by a factor selected based on a characteristic of the input signal. The digital down converter further includes a signal conditioning circuit, coupled to the output of the decimation circuit, that conditions the decimated signal, an interpolator, coupled to the decimation circuit, that increases the number of samples in the conditioned signal, and a second mixer circuit, coupled to the interpolator, the second mixer circuit adapted to modulate a carrier with the conditioned signal.

### TECHNICAL FIELD

The present invention relates generally to the field of electronics and, in particular, to the digital down conversion of signals.

### BACKGROUND

Coaxial cable networks have been used to deliver high quality video programming to subscribers for many years. Conventionally, these networks have been unidirectional, broadcast networks with a limited number of channels and a limited variety of content provided to the subscribers. In recent years, cable companies have developed systems to provide bi-directional communication over their existing networks to provide a wider variety of services and content to their subscribers. For example, many cable companies now provide connection to the Internet through the use of cable modems.

The cable industry has developed a number of standards for delivering data over their networks to provide a uniform basis for the design and development of the equipment necessary to support these services. For example, a consortium of cable companies developed the Data Over Cable Service Interface Specifications (DOCSIS) standard. The DOCSIS standard specifies the necessary interfaces to allow for transparent, bi-directional transfer of Internet Protocol (IP) traffic between a cable head end and customer equipment over a cable or hybrid fiber/coax network.

A cable modem termination system (CMTS) is included in the head end of the cable network for processing the upstream and downstream transmission of data. In the upstream, the CMTS down converts the data signals to base band or a low intermediate frequency, then demodulates the signals. One problem with the design of the CMTS in many systems is in the complexity and expense of the down conversion circuitry. Typically, this down conversion is accomplished with a large number of analog components that impose requirements in space, expense, complexity, and time to implement and tune properly. Further, since there are multiple standards for providing data over a cable network, existing products are either limited to supporting a single standard or having another level of complexity added to the design of the analog circuitry.

For the reasons stated above, and for other reasons stated below which will become apparent to those skilled in the art upon reading and understanding the present specification, there is a need in the art for improvements in down conversion in communication systems.

### SUMMARY

The above mentioned problems with digital down conversion in communication systems and other problems are addressed by embodiments of the present invention and will be understood by reading and studying the following specification.

In one embodiment, a digital down converter is provided. The digital down converter includes an input adapted to receive an input signal and a mixer circuit coupled to the input to down convert the input signal. The digital down converter further includes a decimation circuit, coupled to the mixer. The decimation circuit is adapted to decimate the down converted signal by a factor selected based on a characteristic of the input signal. In addition, the digital down converter includes a signal conditioning circuit, coupled to the output of the decimation circuit, that conditions the decimated signal, an interpolator, coupled to the decimation circuit, that increases the number of samples in the conditioned signal, and a second mixer circuit, coupled to the interpolator, the second mixer circuit adapted to modulate a carrier with the conditioned signal.

In another embodiment, a method for down converting a signal is provided. The method includes mixing the input signal to down convert the signal and decimating the down converted signal based on a selected decimation factor based on the frequency band used for carrying data of an input signal the selected decimation factor. The method further includes conditioning the decimated signal, interpolating the conditioned signal, and modulating a carrier with the interpolated signal.

### BRIEF DESCRIPTION OF THE DRAWINGS

FIG. 1 is a block diagram of one embodiment of digital down converter according to the teachings of the present invention.

FIG. 2 is a block diagram of another embodiment of a digital down converter according to the teachings of the present invention.

FIG. 3 is a block diagram of another embodiment of a digital down converter according to the teachings of the present invention.

FIG. 4 is a block diagram of another embodiment of a digital down converter channel according to the teachings of the present invention.

FIG. 5 is a block diagram of an embodiment of an oscillator for the digital down converter channel of FIG. 4.

FIG. 6 is a block diagram of an embodiment of a mixer for the digital down converter channel of FIG. 4.

FIG. 7 is a block diagram of an embodiment of a decimator for the digital down converter channel of FIG. 4.

FIG. 8 is a block diagram of another embodiment of a decimator for the digital down converter channel of FIG. 4.

FIG. 9 is a block diagram of an embodiment of a filter for the digital down converter channel of FIG. 4.

FIG. 10 is a block diagram of an embodiment of a gain circuit for the digital down converter channel of FIG. 4.

FIG. 11 is a block diagram of an embodiment of an interpolator for the digital down converter channel of FIG. 4.

FIG. 12 is a block diagram of another embodiment of a mixer for the digital down converter channel of FIG. 4.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention introduce the use of a digital down converter for a cable modem termination system (CMTS) in a cable head end. Use of a digital down converter advantageously reduces the number of components required to implement the down conversion function. Further, the use of a digital down converter allows the down converter to be implemented in a single Application Specific Integrated Circuit (ASIC). Further, in some embodiments, the same digital down converter can be used with signals that are generated by equipment compliant with various standards by supplying appropriate control signals to components of the digital down converter as described in more detail below. Finally, embodiments of the present invention allow for selective routing of signals from one or more coaxial cables to a plurality of digital down converters on a single chip to allow flexibility to service providers in laying out their head end equipment as described in more detail below.

### I. First Embodiment

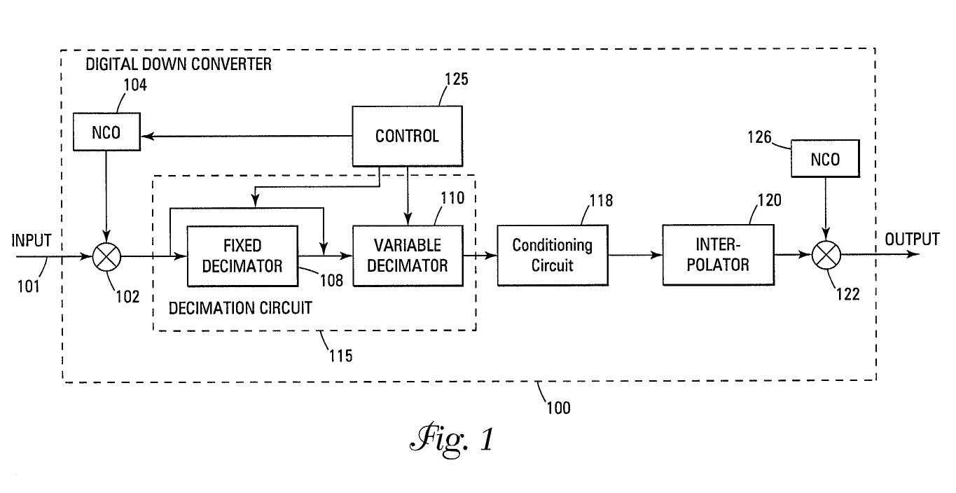

FIG. 1 is a block diagram of one embodiment of digital down converter, indicated generally at 100, according to the teachings of the present invention. Digital down converter 100 receives an input signal at input 101. Advantageously, digital down converter 100 is designed to accept signals at input 101 that comply with a number of standards, including but not limited to, the DOCSIS standard, the Euro-DOCSIS standard and other appropriate standards for providing data over a cable network. The initial down conversion is accomplished with a mixer circuit containing a mixer 102 and a numerically controlled oscillator 104. Mixer 102 mixes the input signal with an output of numerically controlled oscillator 104, which produces a down converted signal from the received input signal.

Digital down converter 100 further includes decimation circuit 115 that selectively decimates the down converted signal. Decimation circuit 115 reduces the sampling rate of the input signal down so as to reduce the burden and power consumption of the circuitry used to further process the signal. The decimation factor used in decimating the down converted signal is based on a characteristic of the input signal. In one embodiment, the decimation factor is based on the frequency band used for carrying data in the input signal. It is this ability to select the decimation factor that allows digital down converter 100 to be used with signals compliant with any of a number of different standards.

Decimation circuit 115 prepares the input signal for further processing. Signal conditioning circuit 118 is coupled to decimation circuit 115 to provide the further processing. In one embodiment, signal conditioning circuit 118 is a low pass filter. In another embodiment, signal conditioning circuit 118 is a finite impulse response low pass filter. In other embodiments, signal conditioning circuit 118 is any other appropriate circuit for conditioning the signal from decimation circuit 115.

In one embodiment, decimation circuit 115 accomplishes the selective decimation of the input signal using two main components. These components include a bypassable fixed decimator 108 and a variable decimator 110. In one embodiment, bypassable fixed decimator 108 is a 2:1 decimator and variable decimator 110 is variable between a 4:1 or 5:1 decimator. The decimation factors for bypassable fixed decimator 108 and variable decimator 110 are chosen based on the ratio of the number of samples per second of the input signal to a desired number of samples per second for signal conditioning circuit 118. For example, when the input signal is from a DOCSIS compliant system, the input signal is typically on the order of 100 Megasamples/second. In one embodiment, it is desired that the signal provided to signal conditioning circuit 118 be on the order of 20 Megasamples per second. Thus, in this case, the bypassable fixed decimator 108 is bypassed and the variable decimator is set to a 5:1 decimation factor. In the case of Euro-DOCSIS, the input signal typically comprises 200 Megasamples/second. Thus, to provide 20 Megasamples/second to signal conditioning circuit 118, decimation circuit 115 provides a 10:1 decimation factor. This is accomplished by not bypassing bypassable fixed decimation circuit 108 and providing a 5:1 decimation factor for variable decimator 110.

Signal conditioning circuit 118 is coupled to interpolator 120, which in turn is coupled to a mixer 122. Interpolator 120 increases the number of samples in the conditioned signal. In one embodiment, interpolator 120 is a 2:1 interpolator and increases the number of samples in the conditioned signal by a factor of 2. The interpolated signal is then received by mixer 122 with an output of NCO 126 in order to modulate a carrier with the conditioned for output.

Control circuit 125 controls the operation of various aspects of digital down converter 100. NCO 104 chooses the carrier frequency at which a channel is captured from the input signal based on control signals from control circuit 125. The carrier frequency is mixed with the input signals to take the desired upstream signals and cast them down to baseband. In one embodiment, baseband is 0 MHz. System 100 further includes a control circuit 125 coupled to NCO 104 and decimation circuit 115. Control circuit 125 steps the NCO 104 through a plurality of frequencies of the frequency spectrum. Further, control circuit 125 selectively controls the frequency of the down converted signals from mixer 102 to measure power over a frequency spectrum of the input signal.

In one embodiment, for operation on a DOCSIS input signal received at 100 Megasamples/second, the fixed decimator 108 is selectably bypassed based on control signals received from control circuit 125. The input signal is then decimated by 5:1 in variable decimator 110 to obtain a decimated signal at 20 Megasamples/second. In this embodiment, the 20 Megasamples/second signal is filtered via a low pass filter (signal conditioning circuit 118) which rejects everything above 3.2 MHz. Once the signal has been filtered so that it does not have any undesirable signals or signal components the filtered signal is then modified to modulate onto a carrier. This is done by interpolating the signal via interpolator 120 and mixing the signal with signals from NCO 126.

In another embodiment, the input signal is received at 160 Megasamples/s and decimator 108 is selected and brings the signal down to 80 Megasamples/s. The variable decimator 110 receives the signal and is selected for 4:1 decimation and decimates the signal to a 20 Megasample/second signal. In one embodiment, the combination of a 2:1 selectable fixed decimator 108 and a variable 4:1 or 5:1 decimator 110 allows an input sampling rate of 100, 160, or 200 Megasamples/second. The use of a 160 Megasamples/second signal reduces the power usage of the digital down converter 100 and is still a high enough frequency to capture the entire EuroDOCSIS upstream band of 5-65 MHz.

In operation, digital down converter 100 receives an input signal and mixes the signal via mixer 102 with signals of NCO 104 the result is a digitally down converted signal. Mixer 102 and NCO 104 comprise a mixer circuit. The digitally downconverted signal is received by decimation circuit 115. Decimation circuit 115 decimates the output signal of mixer 102 based on control signals received from control circuit 125. The received control signals are based on the frequency of the input signal in order to produce an output signal for modulation onto a carrier by the second mixer 122.

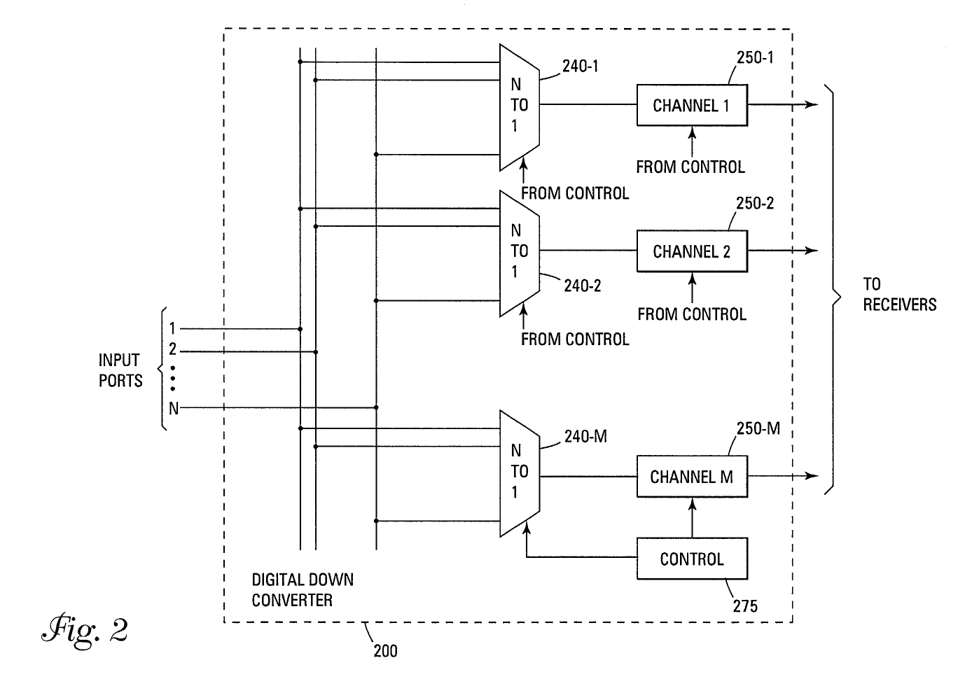

FIG. 2 is a block diagram of another embodiment of a digital down converter, indicated generally at 200, according to the teachings of the present invention. Digital down converter 200 includes a plurality of input ports 1 to N. Digital down converter 200 also includes a plurality of N to 1 multiplexers 240-1 to 240-M. Each N to 1 multiplexer 240-1 to 240-M is coupled to a channel 250-1 to 250-M. In one embodiment, each of channels 250-1 to 250-M comprises a digital down converter circuit of the type described above with respect to FIG. 1. In other embodiments, other appropriate digital down converter circuits are used. Each channel 250-1 to 250-M is coupled to a receiver.

Channels 250-1 to 250-M each down convert a selectable channel from a selected one of the input ports 1 to N under the control of control circuit 275. Control circuit 275 includes a control signal applied to each of the multiplexers 240-1 to 240-M. Further, control circuit 275 also provides appropriate control signals to channels 250-1 to 250-M.

In operation, input signals received over one or more cables at input ports 1 to N are selectively applied to channels 250-1 to 250-M for down conversion. Each N to 1 multiplexer 240-1 to 240-M selects an input signal from one of the input ports 1 to N under control of control circuit 275. Each channel 250-1 to 250-N then selects one frequency in the upstream band to down convert for the receiver. For example, in one embodiment, a single fiber node is received at one of input ports 1 to N and each channel 250-1 to 250-M tunes to a selected portion of the upstream frequency spectrum. In another embodiment, one cable from a distinct fiber node is coupled to each port 1 to N. In this embodiment, each channel 250-1 to 250-M is tuned to a selected channel on any one of the cables. . In another embodiment, any combination of single fiber node cables are couple to input ports 1 to N with each channel tuned to a selected portion of the frequency spectrum on any one of the cables.

### II. Second Embodiment

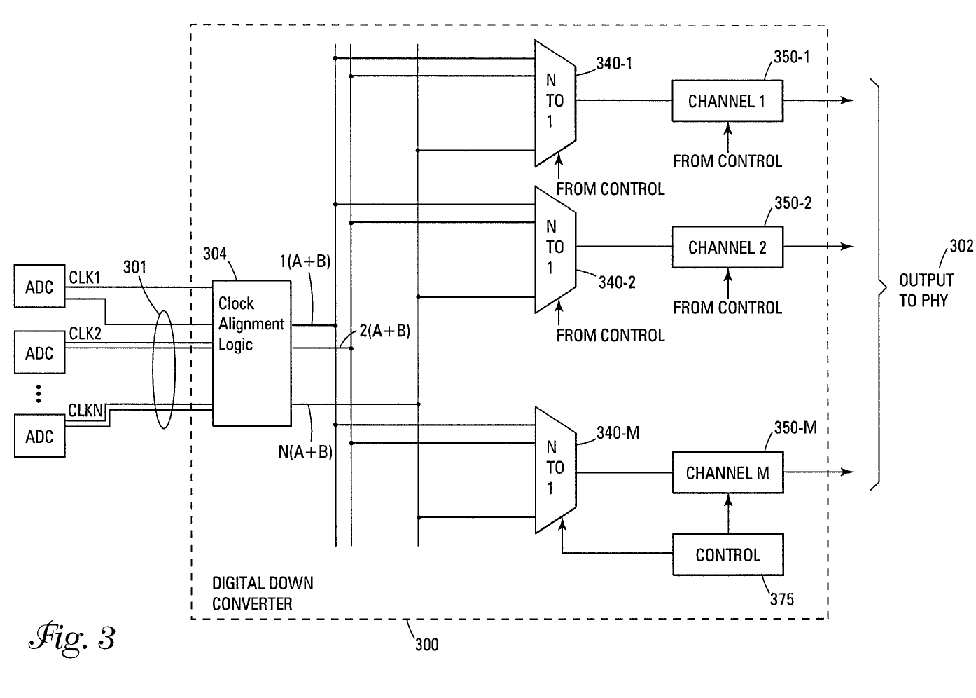

FIG. 3 is a block diagram of a second embodiment of the present invention. This embodiment provides a digital down converter, indicated generally at 300. Digital down converter 300, in one embodiment, is formed as an Application Specific Integrated Circuit (ASIC) that can receive up to six RF connections at 5-65 MHz at N inputs 301. Digital down converter 300 down converts up to six channels of upstream data from the inputs 301. The received channels are presented to a PHY, e.g., the BCM 3137 Universal Burst Receiver commercially available from Broadcom Corporation of Irvine, Calf., as intermediate frequency signals centered at 5.12 MHz at output 302. Digital down converter 300 accepts input data streams at up to 204.8 Megasamples per second, using parallel inputs at 102.4 MHz. Further, the embodiment provides output samples to the PHY at 40.96 Megasamples per second.

Digital down converter 300 can receive samples from up to six analog-to-digital converters (ADC) 303. Each ADC 303 can provide its own sample clock to the digital down converter 300, but the six clocks must be synchronized to within 5 nanoseconds (ns) of each other. The clock labeled CLK1 in FIG. 3 is used as a master clock and is doubled in an on-chip PLL and then divided down to the 40.96 MHz output clock. Digital down converter 300 uses a variable clock divider to provide input flexibility. The clock divider is controlled using the DIV[1:0] pins, as shown in Table 1.

TABLE 1
Input Frequencies

| | | | | Input | Input |
|---|---|---|---|---|---|
| | | Input | Output | Bandwidth | Bandwidth |
| | Clock | Clock | Clock | (2 samples/ | (1 sample/ |
| DIV[1:0] | Divisor | (MHz) | (MHz) | cycle) | cycle) |
| 0 | 1 | 40.96 | 40.96 | 5-40 MHz | 5-20 MHz |
| 1 | 2 | 81.92 | 40.96 | 5-81 Mhz | 5-40 MHz |
| 2 | 2.5 | 102.4 | 40.96 | 5-102 MHz | 5-51 MHz |
| 3 | 3 | 122.88 | 40.96 | 5-122 MHz | 5-61 MHz |

The input samples are received by a crossbar illustrated as multiplexers 340-1 to 340-M, which can connect any input signal 301 to any digital down converter channel 350-1 to 350-M. A single input stream may be directed to multiple channels, allowing several upstream frequencies to be selected from a single input. The outputs from ADCs 303 may be up to twelve bits wide. Each input port has an A and a B sample input. ADCs 303 that provide two samples per cycle connect to both the A and the B inputs, and the B input should be the later sample than the A input. ADCs 303 that provide a single sample per cycle, are connected to just the A inputs.

The inputs 301 are received through clock alignment logic 304. Clock alignment logic 304 brings the six individual clock domains into a single core clock domain. The clock alignment logic 304 also has control bits that can convert the data from unsigned to two's complement, swap the A and B ports, or swap the input busses from most significant bit to least significant bit for ADCs 303 with pinouts that make the module wiring difficult in the default order. The clock alignment block 304 can accept inputs from ADCs 303 in either parallel or interleaved format.

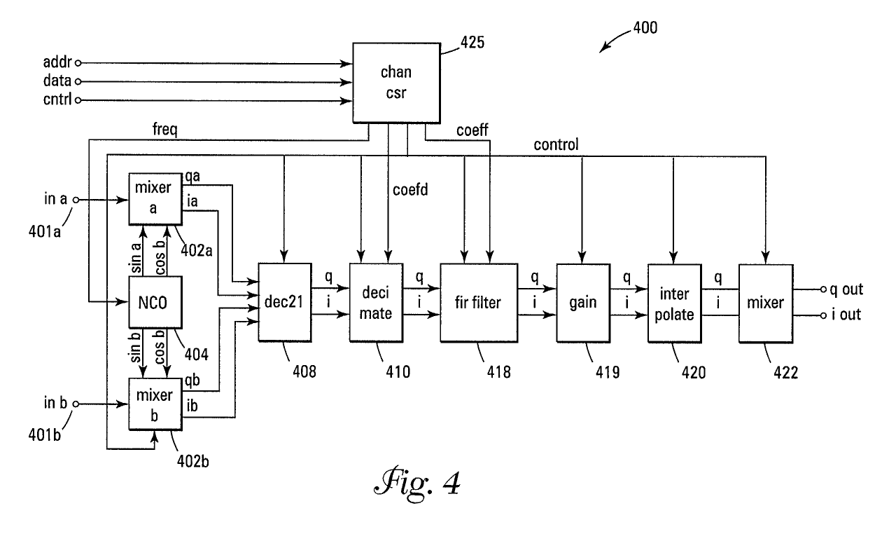

FIG. 4 is a block diagram of an embodiment of a digital down converter channel, indicated generally at 400, according to the teachings of the present invention. Channel 400 receives an input signal at inputs 401a and 401b. Advantageously, channel 400 is designed to accept signals at inputs 401a and 401b that comply with a number of standards, including but not limited to, the DOCSIS standard, the Euro-DOCSIS standard and other appropriate standards for providing data over a cable network.

Digital down converter 400 down converts the input stream at inputs 401a and 401b under the control of channel control and state register (CSR) 425. Digital down converter 400 converts the input stream to baseband using a numerically controlled oscillator (NCO) 404 and mixers 402a and 402b. In one embodiment, NCO 404 is tunable from −65 to 65 MHz. The down converted data is then sent through a series of decimating filters 408 and 410. In one embodiment, the output of decimating filters 408 and 410 is “I” and “Q” sample streams at 20.48 megasamples per second. These sample streams are filtered through filter 418. In one embodiment, filter 418 comprises a low-pass 53 tap FIR filter with programmable coefficients. In one embodiment, filter 418 comprises a filter with a 1.6 MHz bandwidth. In another embodiment, filter 418 comprises a filter with a 3.2 MHz bandwidth. In other embodiments, other appropriate bandwidths are used as necessary.

In one embodiment, the baseband output of filter 418 provides an output for channel 400. In other embodiments, the output of filter 418 is further processed by gain stage 419 and interpolator 420. The output of interpolator 420 is mixed with a 5.12 MHz carrier by mixer 422 to provide an IF output.

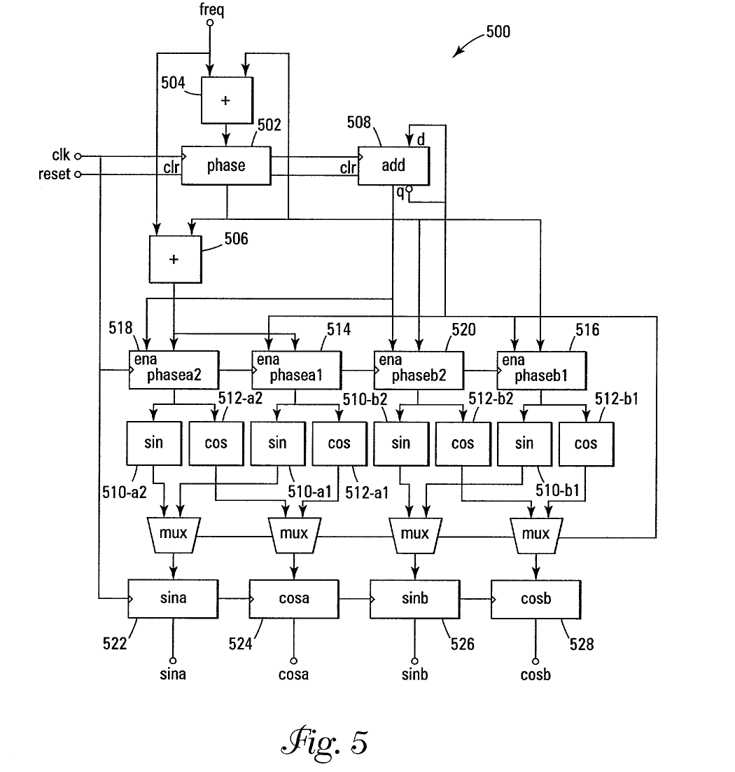

FIG. 5 is a block diagram of an embodiment of an oscillator, indicated generally at 500, for the digital down converter channel 400 of FIG. 4. For example, oscillator 500 is operable to provide appropriate output signals to drive mixers 402a and 402b.

Oscillator 500 is a numerically controlled oscillator, and produces both sine and cosine functions for both the A and B channels. Every clock cycle of clock signal CLK, the input frequency word (freq) is added to the phase accumulator 502 at summer 504. The frequency word divided by two is added to the output of the phase accumulator 502 at summer 506 to compute the phase for the odd, or A, samples. The frequency word is a signed quantity, allowing the oscillator to spin in the opposite direction, effectively swapping sine and cosine or the “Q” and “I” channels.

Oscillator 500 includes a plurality of sine generators 510-a2, 510-a1, 510-b2, and 510-b1 and cosine generators 512-a2, 512-a1, 512-b2, and 512-b1. In one embodiment, the speed of the combinatorial sine generators and cosine generators are not high enough to run at the input clock rate CLK. To allow the logic to run at speed, two complete sets of sine generators and cosine generators are used as shown, running one clock cycle out of phase. The flip-flop odd 508 divides the input clock by two, and is used to alternately load the registers 514 and 516, respectively, and registers, 518 and 520, respectively, and simultaneously select between the sine generators and cosine generators, to load the output registers 522, 524, 526, and 528, respectively.

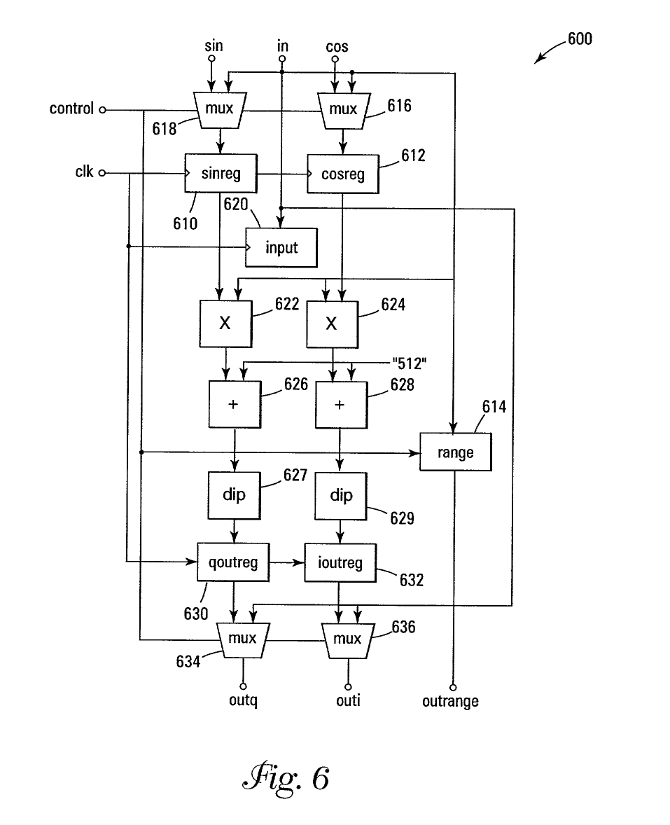

FIG. 6 is a block diagram of an embodiment of a mixer, indicated generally at 600, for the digital down converter channel 400 of FIG. 4. In one embodiment, mixer 600 is used for mixers 402a and 402b of FIG. 4. Mixer 600 receives and stores an input signal in register 620 on each clock cycle. The input data is checked by the block range 614 and an out of range signal is generated when the data is too close to the minimum or maximum signal levels, this threshold is programmable to 25, 12.5, 6.25 or 3.125 percent of below the maximum signal range.

Mixer 600 also receives sine and cosine inputs from an oscillator such as oscillator 500 of FIG. 5. Mixer 600 loads the sine and cosine values into registers 610 and 612, respectively, on every clock cycle. The multiplexers 616 and 618 in front of the sine and cosine registers 612 and 610, respectively, are for chip testing, and switch between the sine and cosine inputs or the delayed input signal.

The content of the input register 620 is multiplied with the content of the sine and cosine registers 610 and 612 at multipliers 622 and 624, to perform the actual mixer function of producing I and Q values. The ten least significant bits of the product are ignored, after adding 512 to cause proper rounding at adders 626 and 628. The result is now clipped to −4096 to 4095, to make sure the output will not wrap at clippers 627 and 629. Every clock cycle the truncated and clipped I and Q values are stored into the output registers 630 and 632. The multiplexers 634 and 636 in the output data path are for chip testing; the input data is gated directly onto the output pins (flow-through mode).

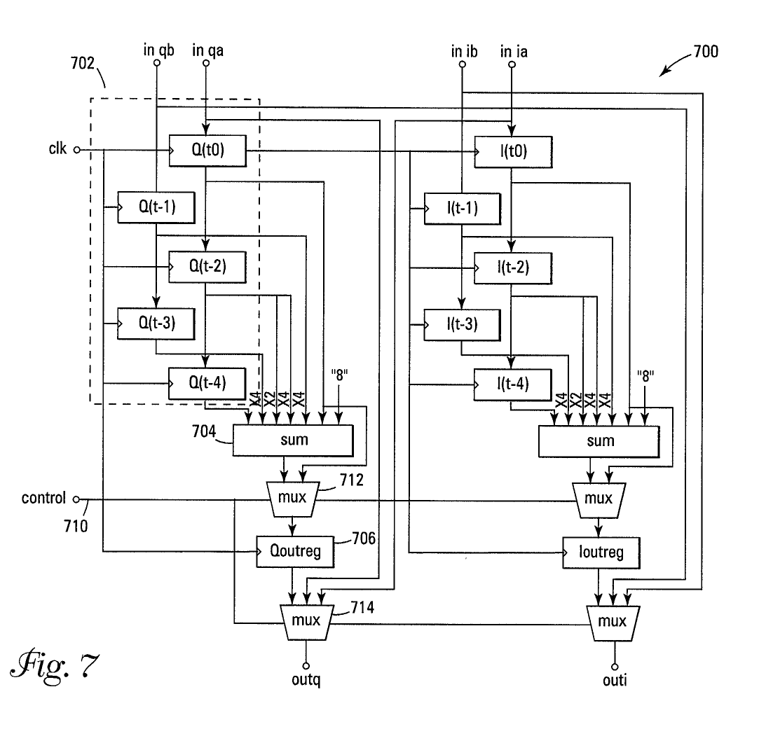

FIG. 7 is a block diagram of an embodiment of a decimator, indicated generally at 700, for the digital down converter channel 400 of FIG. 4. Decimator 700 comprises a two to one decimator that reduces the four input streams (odd and even samples of both the Q and I stream) into just two steams at half the sample rate (Q and I). Since the I and Q data is handled in a similar manner, only the circuitry for handling the Q data is described in detail.

Every clock cycle both the odd and even samples are shifted into a five-sample deep shift register 702. The five samples are added together with weight factors of 1, 4, 6, 4 and 1 respectively by summer 704. To guarantee proper rounding, another “eight” is added to the total sum by summer 704. The four least significant bits are ignored (filter has a gain of 16), and the output is loaded into the output register 706.

Decimator 700 is selectably bypassed by control signal 710 for analog to digital converters that produce just a single stream of samples. Decimator 700 includes multiplexer 712 that is controlled by control signal 710. When decimator 700 is to be bypassed, control signal 710 causes the input register to be clocked into the output register unmodified. Multiplexer 714 is for chip testing; the input data is gated directly onto the output pins (flow-through mode).

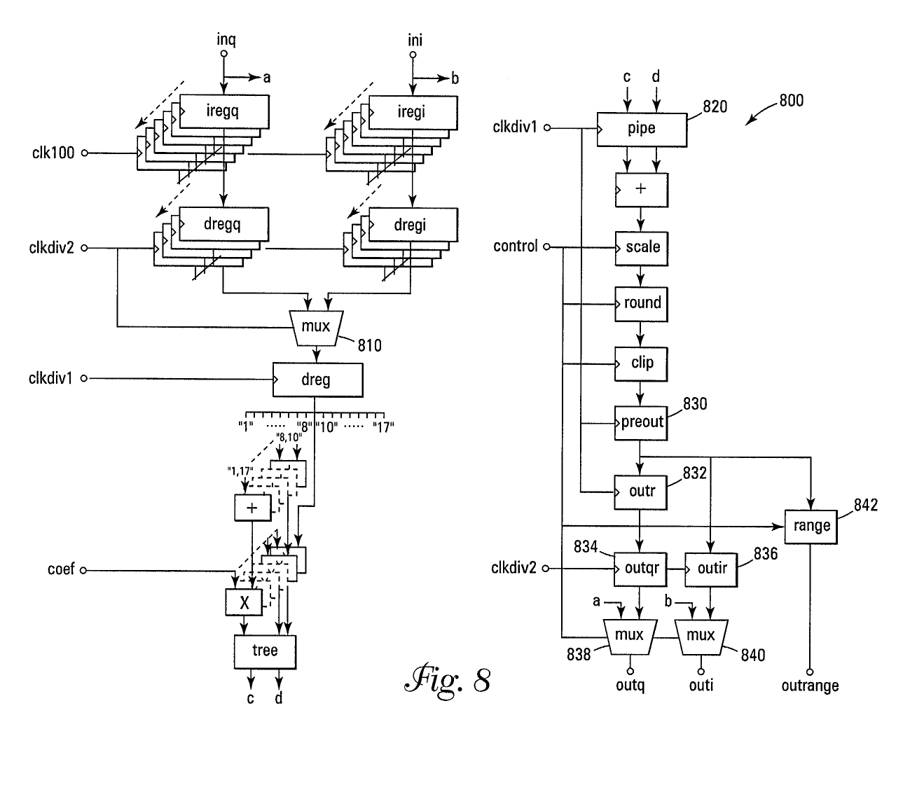

FIG. 8 is a block diagram of another embodiment of a decimator, indicated generally at 800, for the digital down converter channel 400 of FIG. 4. The decimator 800 reduces the sample frequency from the “Q” and “F” streams by a factor between 3 and 6. Six samples of the input signals inq and ini are saved in the input shift registers iregq and iregi respectively. Then 3, 4, 5 or 6 samples at a time are shifted through the shift registers dregq and dregi. The clock used is now the input clock divided by the same factor between 3 and 6. A total of 17 samples are kept in these last two shift registers. To reduce the amount of gates, the next section is shared between the “Q” and “I” data streams, and operates at double the clock rate, alternating between “Q” and “I” samples. The content of dregq and dregi is multiplexed by multiplexer 810 and loaded into the register dreg. The filter operates at 17 samples, and is symmetric; this means that only 9 multiplications have to be performed. The samples 1 and 17, 2 and 16, through 8 and 10 are added first before being multiplied with the filter coefficients. Nine partial multipliers, because of the speed advantage, perform the multiplications. The 18 partial products are added together to form two partial sums, before being loaded into the pipeline register 820. Before load into register 830, the data is scaled (multiplied by the fractional portion of the gain), rounded (a number is added to cause proper rounding), and clipped to the bits specified by the power-of-two gain. Registers 832, 834, and 836 are used to de-multiplex the combined “Q” and “I” stream into two separate data streams. Multiplexers 838 and 840 are for chip testing; the input data is gated directly onto the output pins (flow-through mode). The block “range” 842 checks the signal levels, and an out of range signal is generated when the data is below the minimum or maximum of the range, the threshold is programmable to 25, 12.5, 6.25 or 3.125 percent.

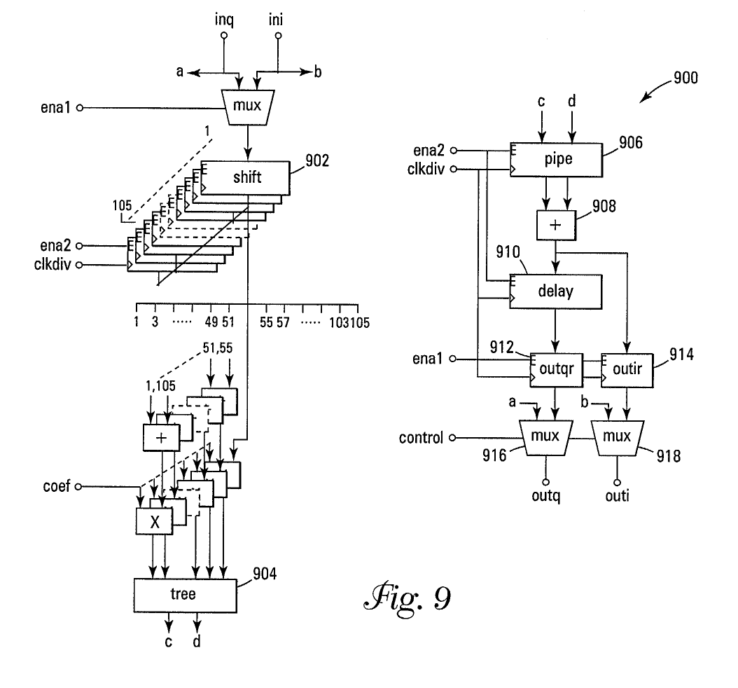

FIG. 9 is a block diagram of an embodiment of a filter, indicated generally at 900, for the digital down converter channel 400 of FIG. 4. Filter 900 is the final band-shaping filter. The filter 900 is a symmetric 53-tap filter running at 20.48 MHz, the 16 outer tap coefficients are 10 bit signed integers, and the remaining 11 inner coefficients are 12 bits signed numbers. To reduce gate-count, there is only one version of the filter, operating at twice the frequency on alternating “Q” and “I” samples. Every ena1 clock cycle, either inq or ini is shifted into a 105 deep shift register 902. The filter 900 operates using all odd samples of the shift register, these are the last 53 samples of either “Q” or “I”. The samples on both sides of the shift register with the same tap coefficients are first added together (26 adders), and then multiplied with its corresponding coefficient. The center tap is multiplied directly with its coefficient. The outputs of the 27 partial multipliers are reduced in a reduction tree 904 to just two partial sums. After pipeline register 906 the partial sums are added together at summer 908. Registers 910, 912, and 914 are for splitting the combined data stream into a separate “Q” and “I” stream. Multiplexers 916 and 918 are for chip testing; the input data is gated directly onto the output pins (flow-through mode).

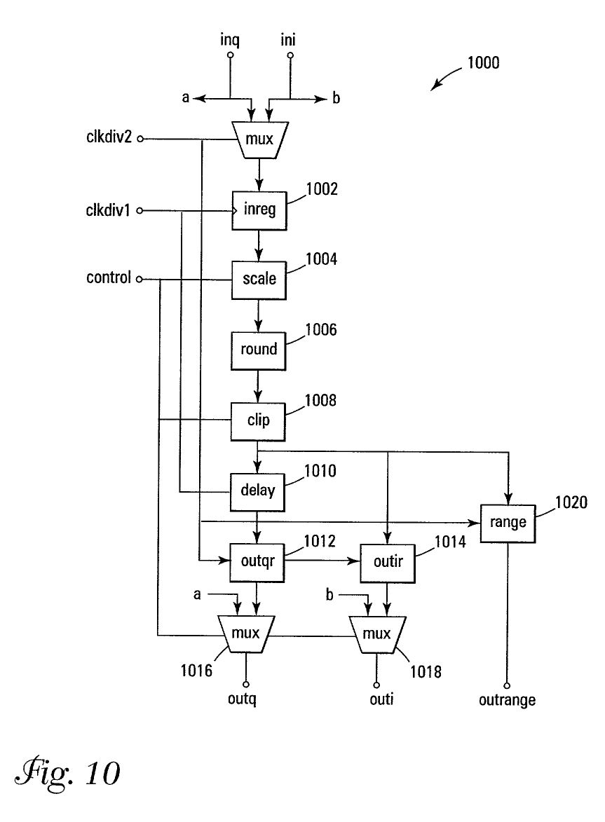

FIG. 10 is a block diagram of an embodiment of a gain circuit, indicated generally at 1000, for the digital down converter channel 400 of FIG. 4. To reduce gate-count, there is only one version of the gain circuit, operating at twice the frequency on alternating “Q” and “I” samples. Every ena1 clock cycle, either inq or ini is shifted into register 1002. The output is multiplied with the fractional scale factor at 1004, rounded at 1006 and clipped at 1008 to the power-of-2 scale factor. Registers 1010, 1012, and 1014 are for splitting the combined data stream into a separate “Q” and “I” stream. Multiplexers 1016 and 1018 are for chip testing; the input data is gated directly onto the output pins (flow-through mode). The block “range” 1020 checks the signal levels, and an out of range signal is generated when the data is below the minimum or maximum of the range, the threshold is programmable to 25, 12.5, 6.25 or 3.125 percent.

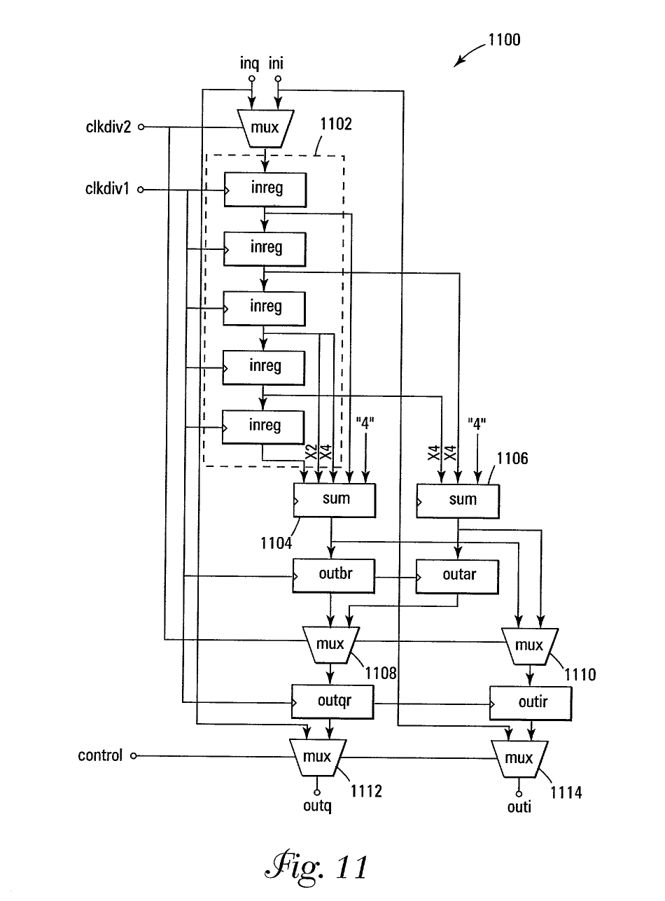

FIG. 11 is a block diagram of an embodiment of an interpolator, indicated generally at 1100 for the digital down converter channel 400 of FIG. 4. Interpolator 1100 doubles the sample frequency from 20.48 to 40.96 MHz. At twice the input rate alternating “Q” and “I” samples are shifted into a 5-sample shift register (inreg) 1102. Summer 1104 adds 3 consecutive samples with weight factors of 1, 6 and 1 computes the even samples; an additional “4” is added for proper rounding. Two consecutive samples with weight factors of 4 and 4, plus an additional “4” for rounding form the odd output samples. The registers outbr and outar and the multiplexers 1108 and 1110 are to separate the data into separate “Q” and “F” streams, before being loaded into the output registers outqr and outir. Multiplexers 1112 and 1114 are for chip testing; the input data is gated directly onto the output pins (flow-through mode).

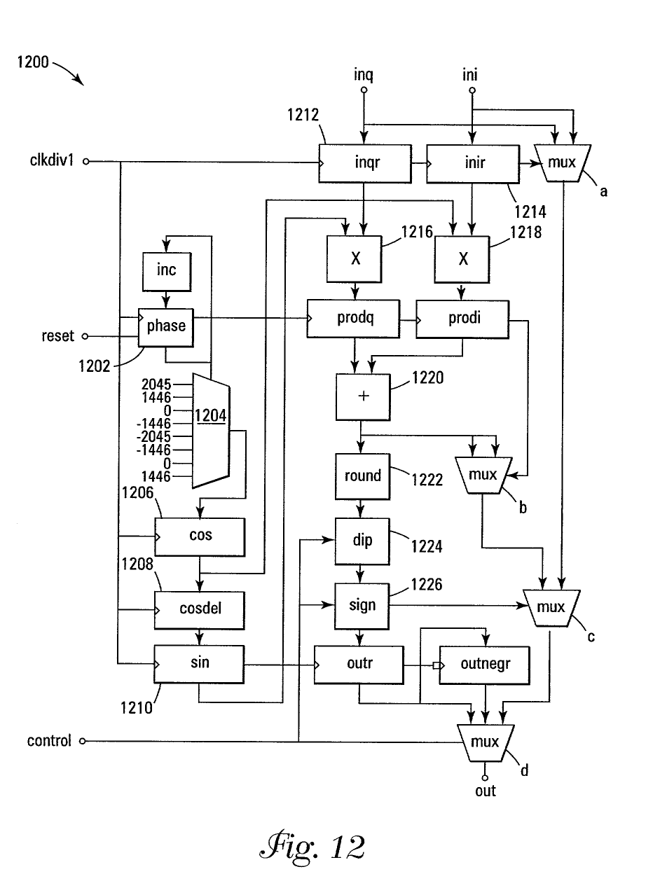

FIG. 12 is a block diagram of another embodiment of a mixer, indicated generally at 1200 for the digital down converter channel 400 of FIG. 4. Mixer 1200 mixes the base-band “Q” and “I” signals with a 5.12 MHz fixed frequency, to produce a signal centered around 5.12 MHz. The fixed frequency oscillator consists of a 3-bit phase accumulator 1202, and a one out of 8 multiplexer 1204. The input of the multiplexer 1204 is hardwired to cosine table with numbers every 45 degrees. The numbers of 2045 and 1448 are selected because of the small rounding error (½*sqrt(2) *2045=1446). The output of the multiplexer is stored in register 1206 and delayed 2 clock cycles (90 degrees) by delay 1208 and register 1210 to form the sine function stored in register 1210.

The “Q” and “I” inputs are stored in registers 1212 and 1214. These I and Q values are multiplied at multipliers 1216 and 1218 with sine and cosine functions from registers 1206 and 1210, respectively. The output of the multipliers 1216 and 1218 are added together in adder 1220, rounded at 1222 and clipped at 1224. The signal has now been converted from I and Q at basebend to a modulated signal at a 5.12 MHz intermediate frequency (IF). The output can be selected between 2's complement and unsigned by the logic at 1226 and is registered in output register outr. The output is then reregistered in register outnegr using the falling edge of the clock, and the control logic can select between the output from the rising edge triggered flop or the falling edge triggered flop using mux d. Muxes a, b, c and d can be used for chip testing to bypass either ini or inq to the output, or to select either the most significant output bits of adder 1220 or the least significant bits of adder 1220 to the output.

### CONCLUSION

Although specific embodiments have been illustrated and described herein, it will be appreciated by those of ordinary skill in the art that any arrangement, which is calculated to achieve the same purpose, may be substituted for the specific embodiments shown. For example, in the embodiment of FIG. 2, any appropriate type of down conversion circuit can be used in channels 250-1 to 250-M. Further, other circuits can be used to achieve the variable decimation factor of decimation circuit 115 without departing from the scope of the present invention. This application is intended to cover any adaptations or variations of the present invention. Therefore, it is intended that this invention be limited only by the claims and the equivalents thereof.

What is claimed is:

1. A digital down converter, comprising:
an input adapted to receive an input signal;
a mixer circuit coupled to the input adapted to down convert the input signal;
a decimation circuit, coupled to the mixer, the decimation circuit adapted to decimate the down converted signal by a factor selected based on a characteristic of the input signal;
a signal conditioning circuit, coupled to the output of the decimation circuit, that conditions the decimated signal;
an interpolator, coupled to the decimation circuit, that increases the number of samples in the conditioned signal; and
a second mixer circuit, coupled to the interpolator, the second mixer circuit adapted to modulate a carrier with the conditioned signal.

2. The digital down converter of claim 1, wherein the decimation circuit includes:
a variable decimator; and
a fixed decimator, bypassably coupled in series with the variable decimator, wherein the variable and fixed decimators are controlled to decimate the down converted signal by a factor selected based on the frequency band used for carrying data in the input signal.

3. The digital down converter of claim 1, wherein the signal conditioning circuit comprises a low pass filter.

4. The digital down converter of claim 1, wherein the signal conditioning circuit comprises a finite impulse response low pass filter.

5. The digital down converter of claim 1, wherein the decimation circuit comprises a decimation circuit that decimates the down converted signal based on the frequency band used to carry data in the input signal.

6. The digital down converter of claim 1, wherein the first and second mixer circuits each include a numerically controlled oscillator.

7. A method for down converting a signal, the method comprising:
mixing the input signal to down convert the signal;
decimating the down converted signal based on a selected decimation factor based on the frequency band used for carrying data of an input signal the selected decimation factor;
conditioning the decimated signal;
interpolating the conditioned signal; and
modulating a carrier with the interpolated signal.

8. The method of claim 7, wherein conditioning the signal comprises filtering the signal.

9. The method of claim 7, wherein conditioning the signal comprises filtering the signal with a low pass filter.

10. The method of claim 7, and further comprising selecting a frequency to down convert with the mixer.

11. A digital down converter, comprising:
an input adapted to receive an input signal;
a mixer circuit coupled to the input to down convert the input signal;
a decimation circuit, coupled to the mixer, the decimation circuit including:
a variable decimator, and
a fixed decimator, bypassably coupled in series with the variable decimator, wherein the variable and fixed decimators are controlled to decimate the down converted signal by a factor selected based on the frequency band used for carrying data in the input signal;
a filter, coupled to the output of the decimation circuit, that conditions the decimated signal;
an interpolator, coupled to the decimation circuit, that increases the number of samples in the filtered signal; and
a second mixer circuit, coupled to the interpolator, the second mixer circuit adapted to modulate a carrier with the filtered signal.

12. The digital down converter of claim 11, wherein the filter comprises a low pass filter.

13. The digital down converter of claim 11, wherein the filter comprises a finite impulse response low pass filter.

14. The digital down converter of claim 11, wherein the first and second mixer circuits each include a numerically controlled oscillator.

15. A digital down converter, comprising:
a plurality of ports;
a plurality of multiplexers, each multiplexer having a plurality of inputs with each input coupled to one of the plurality of ports;
a plurality of digital down converter channels, each channel coupled to one of the plurality of multiplexers; and
a control circuit, coupled to the plurality of multiplexers and the plurality of down converter channels, the control circuit adapted to select a frequency band of a signal received at one of the plurality of ports for processing by each of the digital down converter channels.

16. The digital down converter of claim 15, wherein each of the plurality of digital down converter channels includes:
an input adapted to receive an input signal;
a mixer circuit coupled to the input to down convert the input signal;
a decimation circuit, coupled to the mixer, the decimation circuit adapted to decimate the down converted signal by a factor selected based on a characteristic of the input signal;
a signal conditioning circuit, coupled to the output of the decimation circuit, that conditions the decimated signal;
an interpolator, coupled to the decimation circuit, that increases the number of samples in the conditioned signal; and
a second mixer circuit, coupled to the interpolator, the second mixer circuit adapted to modulate a carrier with the filtered signal.

17. The digital down converter of claim 16, wherein the decimation circuit includes:
a variable decimator; and
a fixed decimator, bypassably coupled in series with the variable decimator, wherein the variable and fixed decimators are controlled to decimate the down converted signal by a factor selected based on the frequency band used for carrying data in the input signal.

18. The digital down converter of claim 16, wherein the signal conditioning circuit comprises a low pass filter.

19. The digital down converter of claim 16, wherein the signal conditioning circuit comprises a finite impulse response low pass filter.

20. The digital down converter of claim 16, wherein the decimation circuit comprises a decimation circuit that decimates the down converted signal based on the frequency band used to carry data in the input signal.

21. The digital down converter of claim 16, wherein the first and second mixer circuits each include a numerically controlled oscillator.

22. The digital down converter of claim 15, wherein each of the plurality of digital down converter channels includes:
an input adapted to receive an input signal;
a mixer circuit coupled to the input to down convert the input signal;
a decimation circuit, coupled to the mixer, the decimation circuit including:
a variable decimator, and
a fixed decimator, bypassably coupled in series with the variable decimator, wherein the variable and fixed decimators are controlled to decimate the down converted signal by a factor selected based on the frequency band used for carrying data in the input signal;
a filter, coupled to the output of the decimation circuit, that conditions the decimated signal;
an interpolator, coupled to the decimation circuit, that increases the number of samples in the filtered signal; and
a second mixer circuit, coupled to the interpolator, the second mixer circuit adapted to modulate a carrier with the filtered signal.

23. The digital down converter of claim 22, wherein the filter comprises a low pass filter.

24. The digital down converter of claim 22, wherein the filter comprises a finite impulse response low pass filter.

25. The digital down converter of claim 22, wherein the first and second mixer circuits each include a numerically controlled oscillator.
